(19) United States
(12) Patent Application Publication
(10) Pub. No.: US 2008/0307103 A1
(43) Pub. Date: Dec. 11, 2008

(54) MEDIATION FOR AUXILIARY CONTENT IN AN INTERACTIVE ENVIRONMENT

(75) Inventors: James E. Marr, Burlingame, CA (US); Payton R. White, Foster City, CA (US); Stephen C. Detwiler, Oakland, CA (US); Attila Vass, Foster City, CA (US)

Correspondence Address: JOSHUA D. ISENBERG;JDI PATENT, 809 CORPORATE WAY, FREMONT, CA, 94539, US

(73) Assignee: Sony Computer Entertainment Inc., Tokyo (JP)

(21) Appl. No.: 11/759,143

(22) Filed: Jun. 6, 2007

(51) Int. Cl. G06F 15/16

(52) U.S. Cl. 709/231

(57) ABSTRACT

A client device configured to interact with an interactive environment, a computer implemented method for obtaining auxiliary content in such a device, a mediation server, a computer implemented method for managing distribution of auxiliary content with such a server, an auxiliary content distribution method and an auxiliary content distribution system are disclosed

### CROSS-REFERENCE TO RELATED APPLICATION

This application is related to commonly assigned U.S. patent application Ser. No. ______, to James E. Marr et al. entitled “CACHED CONTENT CONSISTENCY MANAGEMENT”, attorney docket number SCEA07011US00, filed the same day as the present application, the entire contents of which are incorporated herein by reference.

### FIELD OF THE INVENTION

This invention is related to advertising and more particularly to distribution of advertising content in an interactive environment.

### BACKGROUND OF THE INVENTION

The growth of the Internet and the popularity of interactive entertainment such as video games have led to opportunities for advertising within video games. At first, advertisements were statically placed within video games. As video game consoles with internet connectivity became available it became possible to update advertisements appearing within video games. This led to many avenues for game console manufacturers and video game companies to generate revenue from the sale of advertising space within video games to one or more advertisers. Advertising content often varies based on the nature of the video game title. In addition certain advertising spaces within the game may be more valuable than others. Furthermore, advertising campaigns may change over time with certain advertisements being phased out as others are phased in. It is therefore useful to have some system for determining which advertisements are to be placed in particular spaces within particular video games during particular periods of time.

Conventionally, a video game console may connect to a distribution server that determines what advertisement to place in a particular advertising space within the game based on considerations such as the game title and the time of day, month year, etc. Often the actual advertising content is stored on a separate server known as a content server. In such a case, the distribution server instructs the game console to contact a particular content server and to request one or more content file or files containing the content for a particular advertising space. The console can then directly contact the content server and request the designated file or files.

It is within this context that embodiments of the invention arise.

### BRIEF DESCRIPTION OF THE DRAWINGS

The teachings of the present invention can be readily understood by considering the following detailed description in conjunction with the accompanying drawings, in which:

FIG. 1 is a schematic diagram of an auxiliary content distribution system according to an embodiment of the present invention.

FIG. 2 is a flow diagram illustrating distribution of auxiliary content according to an embodiment of the present invention.

FIG. 3 is a block diagram illustrating a client device according to an embodiment of the present invention.

FIG. 4 is a block diagram illustrating a mediation server according to an embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

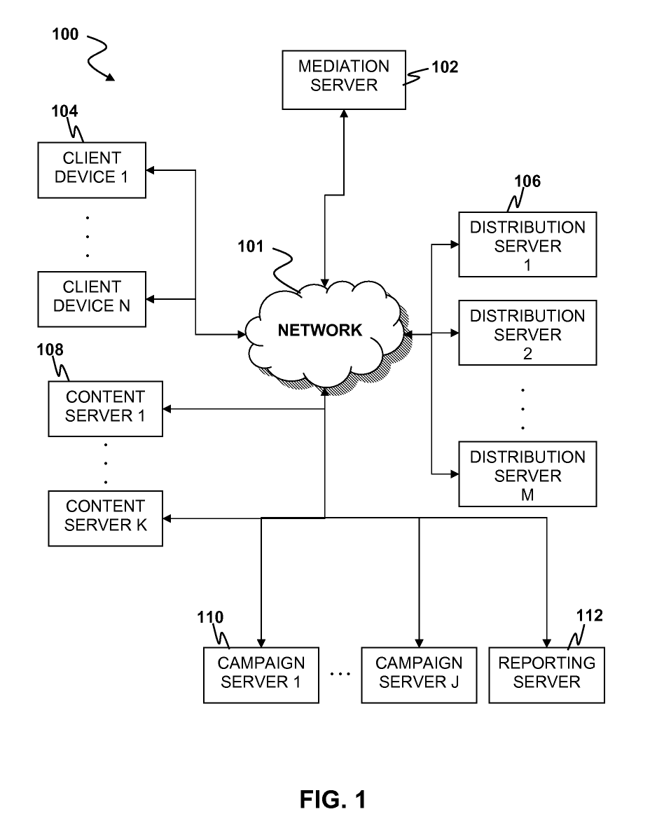

As seen in FIG. 1 an auxiliary content distribution system 100 may include a mediation server 102 one or more client devices 104 and one or more distribution servers 106. The mediation server 102, client devices 104 and distribution servers 106 may be configured to communicate over a network 101. By way of example, and without loss of generality, the network 101 may be a bi-directional digital communications network. The network 101 may be a local area network or wide area network such as the Internet. The network 101 may be implemented, e.g., using an infrastructure, such as that used for CATV bi-directional networks, ISDN or xDSL high speed networks to enable network connections for implementing certain embodiments of the present invention.

By way of example, and without limitation, the client devices 104 may be game consoles. Examples of commercially game consoles include the Xbox® from Microsoft Corporation of Redmond Wash., the Wii® from Nintendo Company, Ltd of Kyoto, Japan and PlayStation® devices, such as the PlayStaion3 from Sony Computer Entertainment of Tokyo, Japan. Xbox® is a registered trademark of Microsoft Corporation of Redmond, Wash. PlayStation® is a registered trademark of Kabushiki Kaisha Sony Computer Entertainment of Tokyo, Japan. Wii® is a registered trademark of Nintendo Company, Ltd of Kyoto, Japan. Alternatively the client devices may be any other type of network capable device that can receive and use auxiliary content. Such devices include, but are not limited to cellular telephones, personal computers, laptop computers, television set-top boxes, portable internet access devices, portable email devices, portable video game devices; personal digital assistants, digital music players and the like. Furthermore, the client devices 104 may incorporate the functions of two or more of the devices in the examples previously listed.

Each client device 104 may be configured to submit input to the mediation server 102. The mediation server 102 is configured to receive the input from the client device 104 and send contact information for a distribution server 106 to the client device 104 in response to the input. Each client device 104 may be further configured to receive the contact information from the mediation server 102 and use the contact information to contact one or more of the distribution servers 106 with a request for advertising content information for an auxiliary content space within an interactive environment implemented with the client device 104. The distribution servers 106 may be configured to service requests for auxiliary content information from the one or more client devices 104.

As used herein, the term auxiliary content means content, e.g., in the form of text, still images, video images, animations, sounds, applets, three-dimensional content, etc, that is provided gratuitously to the client device 104. By way of example, and without limitation, within the context of an interactive environment, e.g., a video game, three-dimensional content may include information relating to images or simulations involving three dimensions. Examples of such information may range from static geometry through to a subset of a game level or a full game level with all of the expressive interactivity of the game title itself. Examples of auxiliary content include advertisements, public service announcements, software updates, interactive game content and the like. The auxiliary content may appear at one or more pre-defined locations or instances of time in a simulated environment generated by the client device 104. As used herein, the term simulated environment refers to text, still images, video images, animations, sounds, etc, that are generated by the client device 104 during operation initiated by a user of the device. By way of example, and without limitation, a simulated environment may be a landscape within a video game that is represented by text, still images, video images, animations, sounds that the client device 104 presents to the user.

The client devices 104 may retrieve the auxiliary content assets from one or more content servers 108. The distribution servers 106 may determine which particular items of auxiliary content belong in particular spaces or time instances within the simulated environments generated by the client devices 104. Each distribution server 106 may be responsible for distribution of auxiliary content to client devices 104 in different regions. The mediation server 102 acts as an intermediary between the client devices 104 and the distribution servers 106. In embodiments of the present invention, the mediation server 102 determines which distribution server 106 handles auxiliary content distribution for a client device in a particular region. The mediation server 102 may have a pre-existing trust relationship with each client device 104. Such a pre-existing trust relationship may be established, e.g., with a cryptographic key pair. The pre-existing trust relationship between the client device 104 and mediation server 102 may be leveraged to delegate management of multiple distribution servers 106.

By way of example, the trust relationship may be established using Public key cryptography, also known as asymmetric cryptography. This form of cryptography involves the use of a pair of cryptographic keys—a public key and a private key. The private key is kept secret, while the public key may be widely distributed. The keys are related mathematically, but the private key cannot be practically derived from the public key. A message encrypted with the public key can be decrypted only with the corresponding private key. Examples of well-known asymmetric key techniques include, but are not limited to, Diffie-Hellman, Digital Signature Standard (DSS), which incorporates the Digital Signature Algorithm, ElGamal, Elliptic Curve techniques, password-authenticated key agreement techniques, Paillier cryptosystem and the RSA encryption algorithm (PKCS).

Specifically, the mediation server 102 may use a private cryptographic key to generate a public cryptographic key that is sent to the client devices 104. The mediation server 102 may use the private cryptographic key to encode messages sent to the client devices 104 and/or decode messages received from the client devices. The client devices 104 may use the public cryptographic key to encode messages sent to the mediation server 102 and/or decode messages received from the mediator.

Such cryptography between the client device 104 and the mediation server 102 may be used to verify that the mediation server 102 is authentic and not an imposter. To achieve this, the mediation server 102 may have a private key and the client device 104 may have a public key that is generated from the private key. When the mediation server 102 communicates with the client device 104, it encrypts its messages using the private key. The client device 104 may then decode the message using the public key, but that public key is not enough information to encrypt messages the same way the mediation server 102 does using the private key. If an imposter pretends to be the mediation server 102, and tries to create its own messages, the client device 104 will fail to decrypt the message. Because the imposter does not have the private mediator cryptography key, there is no way the imposter can correctly encrypt messages in a way the client will be able to decrypt.

By way of example, and without loss of generality, the auxiliary content distributed by the system 100 may include advertising content. Selection of advertising content and targeting of such content to the device 104 may be managed by one or more campaign servers 110 coupled to the network 101. Advertisers may upload advertising content to the content servers 108 via the campaign servers 110. Advertisers may also assign regional responsibility for distribution of advertising content among the distribution servers 106 using the campaign servers 110. Advertisers may then delegate management of these assignments to the mediation server 102. For example, the mediation server 102 may provide cryptographic universal resource locators (URLs) and cryptographic keys to facilitate communication among the campaign servers 110, distribution servers 106 and content servers 108.

In some embodiments, the system 100 may further include one or more reporting servers 112 coupled to the network 101. Client devices 104 may report user activity related to the auxiliary content. For example, in the case of auxiliary content in the form of advertising, the client devices 104 may be configured to report information to the reporting server 112 relating to whether an advertisement was displayed and/or made an impression on the user. Examples of such impression reporting are described, e.g., in commonly-assigned U.S. patent application Ser. No. 11/241,229, filed Sep. 30, 2007, the entire contents of which are incorporated herein by reference. In some embodiments, the mediation server 102 may also provide a URL for a reporting server 112 and a cryptographic key for communicating with the reporting server.

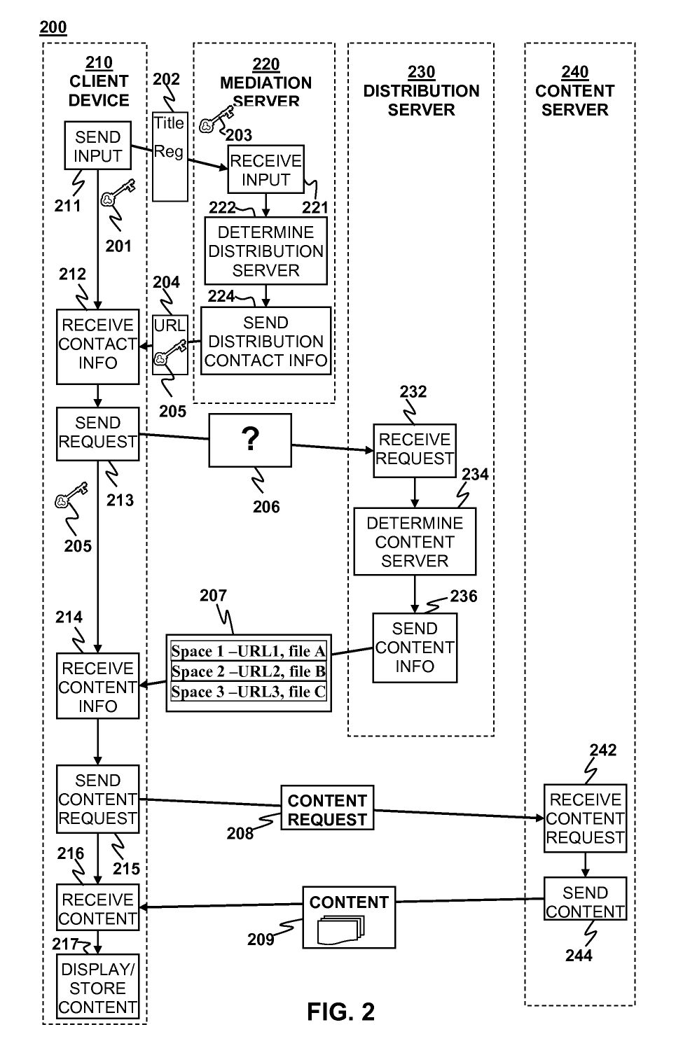

As shown in FIG. 2, the system 100 may be configured to distribute auxiliary content according to an inventive method 200. Various aspects of the method 200 may be implemented by execution of computer executable instructions running on the mediation server 102 and/or client device 104 and/or distribution server 106 and/or content servers 108.

Specifically, a client device 104 may be configured, e.g., by suitable programming, to implement certain client device steps 210. In addition, the mediation server 102 may be configured to implement certain mediation server steps 220. Furthermore, the distribution server 106 and content server 108 may be configured to respectively implement distribution server steps 230 and content server steps 240. Specifically, as indicated at 211 the client device 104 may submit input 202 to the mediation server 102. The input 202 may identify a simulated environment generated by the client device 104 and may provide information that facilitates secure communication between the client device 104 and mediation server 102. By way of example, if the client device is generating a simulated environment in the form of a video game, the input 202 may include a game title. Furthermore, the input 202 may include an identifier for a region associated with the client device 104. In addition, the input 202 may be encrypted according to a predetermined mediation cryptographic key 201. The mediation cryptographic key 201 may be configured to facilitate secure communication between the client device 104 and the mediation server 102. By way of example, the mediation cryptographic key 201 may be a public cryptographic key generated by the mediation server 102 using a private cryptographic key 203. Computer instructions implementing the client device steps 210 may be configured such that the client device 104 cannot properly decrypt the contact information 202 unless it was encrypted using the private cryptographic key 203 on the mediation server 102.

As indicated at 221, the mediation server receives the input 202 from the client device 104 and sends contact information 204 for a distribution server to the client device 104 in response to the input 202. For example, at 222 the mediation server may determine which distribution server 106 is responsible for handling auxiliary content for the client device 104 based on the input 202. By way of example, the mediation server may perform a lookup in a table that relates the distribution server 106 to a particular region, game title or other criteria defined by the input 202. In addition load balancing considerations may be built into the process of determining the distribution server 106 at 222. For example, if two or more distribution servers 106 are responsible for the same region and game title, the mediation server 102 may select from among these distribution servers one that is currently servicing fewer requests for auxiliary content information. Once the appropriate distribution server 106 has been determined, the mediation server 102 may send the contact information 204 regarding the distribution server 106, as indicated at 224. The contact information 204 may include a network address or universal resource locator (URL) for one or more of the distribution servers 106. In addition, the contact information 204 may further include one or more cryptographic keys 205 configured to facilitate secure communication between the client device 104 and the distribution server(s) 106. By way of example, the cryptographic key 205 may be a public key. The contact information may also include a URL and cryptographic key for a reporting server 112.

The client device 104 receives the contact information 204 from the mediation server 102 and uses the contact information to contact one or more of the distribution servers 106 with a request for auxiliary content information for an auxiliary content space within an interactive environment implemented with the client device 104. Specifically, at 213, the client device 104 may send a request 206 for auxiliary content information to a distribution server 106 identified by the contact information 204 from the mediation server 102. The request 206 may be encoded using the included cryptographic key 205. The distribution server 106 may service the request for auxiliary content information from one or more of the client devices 104. Specifically, the distribution server 106 may receive the request 206, as indicated at 232. The distribution server 106 may then determine which of one or more content servers 108 contains the auxiliary content for the client device 104, as indicated at 234. In some cases, auxiliary content for different spaces in the simulated environment may be stored on different content servers 108. After determining which content servers 108 contain the content for the client device 104 the distribution server may send content information 207 to the client device, as indicated at 236. The content information may further contain information indicating which auxiliary content asset is to be displayed in a given auxiliary content space within the simulated environment generated by the client device 104.

By way of example, the content information 207 may provide information for one or more auxiliary content spaces. Each auxiliary content space information may contain a space identifier, a list of one or more assets associated with each space identifier and one or more addresses, e.g., one or more URLs, for one or more selected content servers 108 from which the assets may be downloaded. It is noted that two or more different content servers 108 may be associated with each auxiliary content space. Specifically, this information may be in the form of a list or table associated with each auxiliary content space. The list may identify one or more auxiliary content spaces using space identifiers, one or more URLs and a list of file names for one or more corresponding auxiliary content assets that can be downloaded from each URL. For example, content files A, B, and C may be downloaded at URL1, URL2 and URL3 respectively, for auxiliary content spaces 1, 2 and 3.

After receiving the content information 207, as indicated at 214, the client device 104 may send one or more content requests 208 to the one or more selected content servers 108 as indicated at 215. The content request for each selected content server 108 may include a list of auxiliary content files to be downloaded from the content server 108. Such a list may be derived from the content information 207 obtained from the distribution server 106. After receiving the content request 208, as indicated at 242, the content server may send auxiliary content assets 209 (e.g., text, image, video, audio, animation or other files) corresponding to the requested content, as indicated at 244. The client device 104 may then receive the assets 209 at 216 and (optionally) display the auxiliary content using the assets 209 and/or store the assets as indicated at 217. By way of example, the simulated environment in the form of a video game may include one or more advertising spaces, e.g., billboards, etc. Such spaces may be rendered as images depicting a scene, landscape or background within the game that is displayed visually. Advertising content may be displayed in these spaces may be displayed using the content assets 209 during the course of the normal operation of the game. Alternatively, advertising content assets 209 may be stored in a computer memory or hard drive in locations associated with the advertising spaces and displayed at a later time.

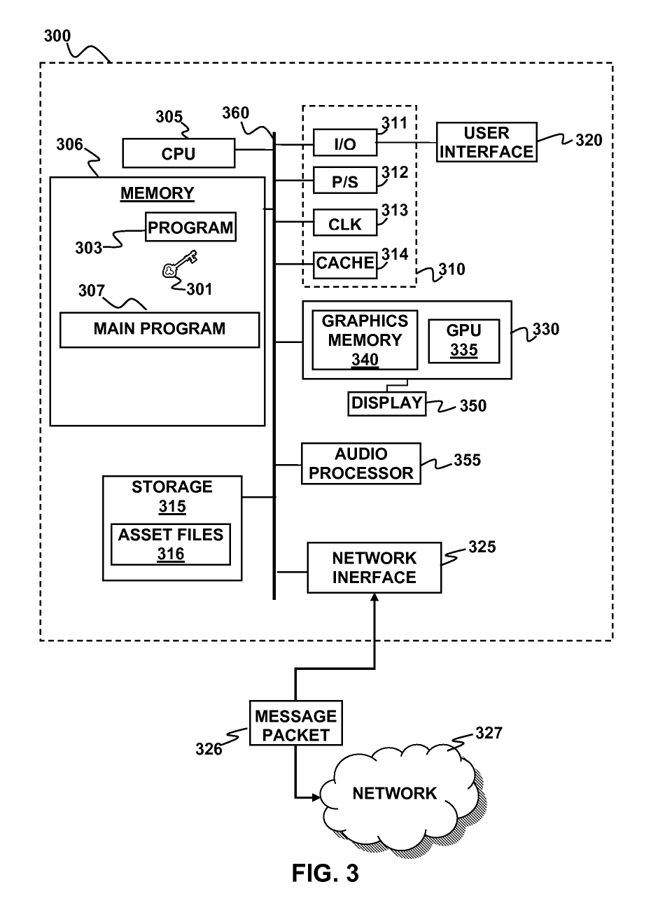

By way of example, the client device may be configured as shown in FIG. 3. FIG. 3 is a block diagram illustrating the components of a client device 300 according to an embodiment of the present invention. By way of example, and without loss of generality, the client device 300 may be implemented as a computer system, such as a personal computer, video game console, personal digital assistant, or other digital device, suitable for practicing an embodiment of the invention. The client device 300 may include a central processing unit (CPU) 305 configured to run software applications and optionally an operating system. The CPU 305 may include one or more processing cores. By way of example and without limitation, the CPU 305 may be a parallel processor module, such as a Cell Processor. An example of a Cell Processor architecture is described in detail, e.g., in Cell Broadband Engine Architecture, copyright. International Business Machines Corporation, Sony Computer Entertainment Incorporated, Toshiba Corporation Aug. 8, 2005 a copy of which may be downloaded at http://cell.scei.co.jp/, the entire contents of which are incorporated herein by reference.

A memory 306 is coupled to the CPU 305. The memory 306 may store applications and data for use by the CPU 305. The memory 306 may be in the form of an integrated circuit, e.g., RAM, DRAM, ROM, and the like). A computer program 303 may be stored in the memory 306 in the form of instructions that can be executed on the processor 305. The instructions of the program 303 may be configured to implement, amongst other things, certain steps of a method for auxiliary content distribution, e.g., as described above with respect to client device steps 210 in FIG. 2. By way of example, the program 303 may include instructions to contact a mediation server, receive contact information for a distribution server from the mediation server and contact the distribution server with a request for auxiliary content information for an auxiliary content space within an interactive environment. The program 303 may operate in conjunction with one or more instructions configured to implement the interactive environment. By way of example, such instructions may be part of a main program 307, such as a video game program. The client device 300 may be configured, by appropriate programming of the program 303, to send a region identifier for the client device 300 and information corresponding to a title for the video game program to the mediation server. The main program may call the program 303, e.g., as a function or subroutine. Alternatively, the main program 307 may be a program for interfacing with a virtual world. Virtual worlds are described in commonly assigned U.S. patent application Ser. Nos. 11/682,281, 11/682,284, 11/682,287, 11/682,292, 11/682,298, and 11/682,299, the contents of all of which are incorporated herein by reference.

In addition, a cryptographic key 301 may be embedded in the memory 306. The cryptographic key may be configured to facilitate secure communication with a mediation server as described above. By way of example, the cryptographic key 301 may be a public key generated by a mediation server using a private key.

The client device 300 may also include well-known support functions 310, such as input/output (I/O) elements 311, power supplies (P/S) 312, a clock (CLK) 313 and cache 314. The client device 300 may further include a storage device 315 that provides non-volatile storage for applications and data. The storage device 315 may be used for temporary or long-term storage of auxiliary content assets 316 downloaded from a content server. By way of example, the storage device 315 may be a fixed disk drive, removable disk drive, flash memory device, tape drive, CD-ROM, DVD-ROM, Blu-ray, HD-DVD, UMD, or other optical storage devices.

One or more user input devices 320 may be used to communicate user inputs from one or more users to the computer client device 300. By way of example, one or more of the user input devices 320 may be coupled to the client device 300 via the I/O elements 311. Examples of suitable input device 320 include keyboards, mice, joysticks, touch pads, touch screens, light pens, still or video cameras, and/or microphones. The client device 300 may include a network interface 325 to facilitate communication via an electronic communications network 327. The network interface 325 may be configured to implement wired or wireless communication over local area networks and wide area networks such as the Internet. The client device 300 may send and receive data and/or requests for files via one or more message packets 326 over the network 327.

The client device 300 may further comprise a graphics subsystem 330, which may include a graphics processing unit (GPU) 335 and graphics memory 340. The graphics memory 340 may include a display memory (e.g., a frame buffer) used for storing pixel data for each pixel of an output image. The graphics memory 340 may be integrated in the same device as the GPU 335, connected as a separate device with GPU 335, and/or implemented within the memory 306. Pixel data may be provided to the graphics memory 340 directly from the CPU 305. Alternatively, the CPU 305 may provide the GPU 335 with data and/or instructions defining the desired output images, from which the GPU 335 may generate the pixel data of one or more output images. The data and/or instructions defining the desired output images may be stored in memory 310 and/or graphics memory 340. In an embodiment, the GPU 335 may be configured (e.g., by suitable programming or hardware configuration) with 3D rendering capabilities for generating pixel data for output images from instructions and data defining the geometry, lighting, shading, texturing, motion, and/or camera parameters for a scene. The GPU 335 may further include one or more programmable execution units capable of executing shader programs.

The graphics subsystem 330 may periodically output pixel data for an image from the graphics memory 340 to be displayed on a display device 350. The display device 350 may be any device capable of displaying visual information in response to a signal from the client device 300, including CRT, LCD, plasma, and OLED displays. The computer client device 300 may provide the display device 350 with an analog or digital signal. By way of example, the display 350 may include a cathode ray tube (CRT) or flat panel screen that displays text, numerals, graphical symbols or images. In addition, the display 350 may include one or more audio speakers that produce audible or otherwise detectable sounds. To facilitate generation of such sounds, the client device 300 may further include an audio processor 355 adapted to generate analog or digital audio output from instructions and/or data provided by the CPU 305, memory 306, and/or storage 315.

The components of the client device 300, including the CPU 305, memory 306, support functions 310, data storage 315, user input devices 320, network interface 325, and audio processor 355 may be operably connected to each other via one or more data buses 360. These components may be implemented in hardware, software or firmware or some combination of two or more of these.

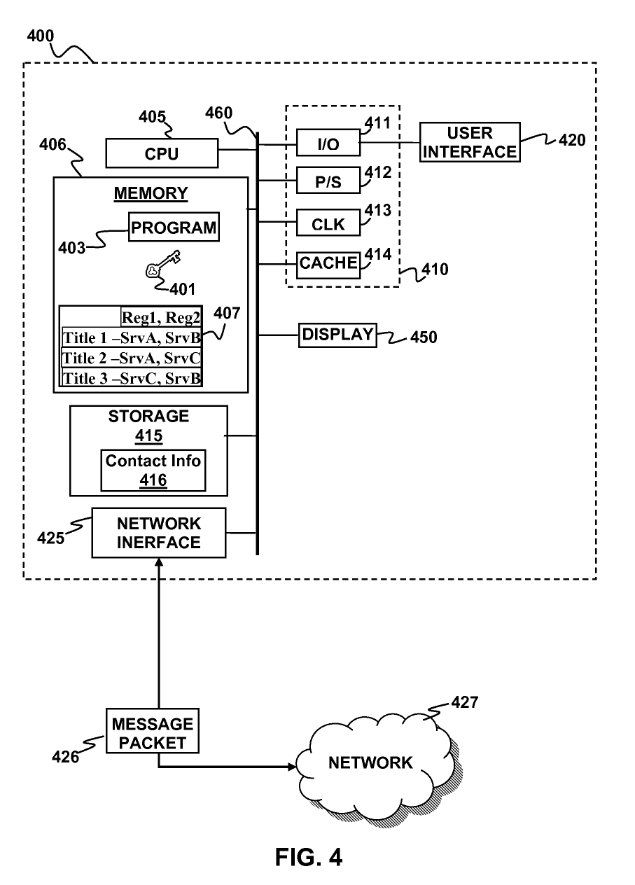

By way of example, a mediation server 400 may be configured as shown in FIG. 4. By way of example, and without loss of generality, the mediation server 400 may be implemented as a computer system or other digital device. The mediation server 400 may include a central processing unit (CPU) 405 configured to run software applications and optionally an operating system. The CPU 405 may include one or more processing cores. By way of example and without limitation, the CPU 405 may be a parallel processor module, such as a Cell Processor.

A memory 406 is coupled to the CPU 405. The memory 406 may store applications and data for use by the CPU 405. The memory 406 may be in the form of an integrated circuit, e.g., RAM, DRAM, ROM, and the like). A computer program 403 may be stored in the memory 406 in the form of instructions that can be executed on the processor 405. The instructions of the program 403 may be configured to implement, amongst other things, certain steps of a method for auxiliary content distribution, e.g., as described above with respect to the mediation server steps 220 in FIG. 2. Specifically, the mediation server 400 may be configured, e.g., through appropriate programming of the program 403, to receive input from a client device, and send to the client device contact information for a distribution server, the contact information being configured to facilitate communication between the client device and the distribution server. The mediation server 400 may be configured, by appropriate programming of the program 403, to receive as input a region identifier for the client device and information corresponding to a title for a video game program. The mediation server 400 may select a particular distribution server from among a plurality of distribution servers based on such inputs. For example, the memory 406 may contain a cross-reference table 407 with a listing of distribution servers organized by game title and region. The program 403 may perform a lookup in the table for the distribution server that corresponds to a region identifier and title in input from the client device.

In addition, a cryptographic key 401 may be embedded in the memory 406. The cryptographic key may be configured to facilitate secure communication with a client device as described above. By way of example, the cryptographic key 401 may be a private key that can be used to generate public keys that can be transmitted to client devices, (such as the client device 300 of FIG. 3, e.g. over a network. The mediation server 400 may also include well-known support functions 410, such as input/output (I/O) elements 411, power supplies (P/S) 412, a clock (CLK) 413 and cache 414.

The mediation server 400 may further include a storage device 415 that provides non-volatile storage for applications and data. The storage device 415 may be used for temporary or long-term storage of contact information 416 such as distribution server addresses and cryptographic keys. By way of example, the storage device 415 may be a fixed disk drive, removable disk drive, flash memory device, tape drive, CD-ROM, DVD-ROM, Blu-ray, HD-DVD, UMD, or other optical storage devices.

One or more user input devices 420 may be used to communicate user inputs from one or more users to the mediation server 400. By way of example, one or more of the user input devices 420 may be coupled to the mediation server 400 via the I/O elements 411. Examples of suitable input device 420 include keyboards, mice, joysticks, touch pads, touch screens, light pens, still or video cameras, and/or microphones. The mediation server 400 may include a network interface 425 to facilitate communication via an electronic communications network 427. The network interface 425 may be configured to implement wired or wireless communication over local area networks and wide area networks such as the Internet. The mediation server 400 may send and receive data and/or requests for files via one or more message packets 426 over the network 427.

The components of the mediation server 400, including the CPU 405, memory 406, support functions 410, data storage 415, user input devices 420, and network interface 425, may be operably connected to each other via one or more data buses 460. These components may be implemented in hardware, software or firmware or some combination of two or more of these.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. In a client device configured to interact with an interactive environment, a computer implemented method for obtaining auxiliary content, comprising:
contacting a mediation server;
receiving contact information for a distribution server from the mediation server; and
contacting the distribution server with a request for advertising content information for an auxiliary content space within the interactive environment using the contact information.

2. The method of claim 1 wherein the contact information includes an address for the distribution server.

3. The method of claim 2 wherein the address includes a universal resource locator (URL) for the distribution server.

4. The method of claim 2 wherein the contact information further includes a cryptographic key configured to facilitate secure communication between the client device and the distribution server.

5. The method of claim 1 wherein contacting the mediation server includes sending a region identifier for the client device to the mediation server.

6. The method of claim 5 wherein contacting the mediation server includes using a cryptographic key embedded within the client device, wherein the cryptographic key is configured to facilitate secure communication between the client device and the mediation server.

7. The method of claim 1 wherein the client device is configured to implement a video game and wherein contacting the mediation server includes sending a region identifier for the client device and information corresponding to a title for the video game to the mediation server.

8. The method of claim 1, further comprising receiving the requested content information from the distribution server.

9. The method of claim 8 wherein the requested content information includes a list of one or more assets for one more auxiliary content spaces within the interactive environment.

10. The method of claim 8 wherein the requested content information includes a list of one or more assets for one more auxiliary content spaces within the interactive environment and an address for a content server.

11. The method of claim 10, further comprising contacting the content server with a request for the one or more assets.

12. The method of claim 11, further comprising receiving the one or more assets from the content server.

13. The method of claim 12, further comprising using the one or more assets to display advertising content in one or more auxiliary content spaces in the interactive environment.

14. A client device configured to interact with an interactive environment, comprising:
a processor;
a memory coupled to the processor;
one or more instructions embodied in memory for execution by the processor, the instructions being configured to implement a method for obtaining auxiliary content for an interactive environment, the method comprising:
contacting a mediation server;
receiving contact information for a distribution server from the mediation server; and
contacting the distribution server with a request for auxiliary content information for an auxiliary content space within the interactive environment.

15. The client device of claim 14, further comprising one or more instructions embodied in memory configured to implement the interactive environment.

16. The client device of claim 14 wherein the interactive environment is a video game.

17. The device of claim 14, further comprising a cryptographic key stored in the memory, wherein the cryptographic key is configured to facilitate secure communication between the client device and the mediation server.

18. In a mediation server, a computer implemented method for managing distribution of auxiliary content, comprising:
receiving input from a client device; and
sending contact information for a distribution server to the client device, the contact information being configured to facilitate communication between the client device and the distribution server.

19. The method of claim 18 wherein the contact information includes an address for the distribution server.

20. The method of claim 19 wherein the address includes a universal resource locator (URL) for the distribution server.

21. The method of claim 18 wherein the contact information includes a cryptographic key configured to facilitate secure communication between the client device and the distribution server.

22. The method of claim 21 wherein the cryptographic key is a public cryptographic key.

23. The method of claim 18 wherein the contact information includes an address for the distribution server and a cryptographic key configured to facilitate secure communication between the client device and the distribution server.

24. The method of claim 23 wherein the cryptographic key is a public cryptographic key.

25. The method of claim 18 wherein receiving input from a client device includes receiving a region identifier for the client device.

26. The method of claim 18 wherein receiving input from a client device includes validating authenticity of the client device using a cryptographic key configured to facilitate secure communication between the client device and the mediation server.

27. The method of claim 26 wherein the cryptographic key is a private cryptographic key.

28. The method of claim 18 wherein receiving input from a client device includes receiving a region identifier for the client device to the mediation server and validating authenticity of the client device using a cryptographic key, wherein the cryptographic key is configured to facilitate secure communication between the client device and the mediation server.

29. The method of claim 28 wherein the cryptographic key is a private cryptographic key.

30. The method of claim 18, further comprising selecting the distribution server from among a plurality of distribution servers based on the input.

31. The method of claim 30 wherein the input includes information corresponding to a region for the client device.

32. The method of claim 30 wherein the input includes corresponding to a title for a software program running on the client device.

33. The method of claim 32 wherein the software program is a video game program.

34. A mediation server, comprising:
a processor;
a memory; and
one or more instructions embodied in memory for execution by the processor, the instructions being configured to implement a method for managing distribution of auxiliary content, the method comprising:
receiving input from a client device; and
sending contact information for a distribution server to the client device, the contact information being configured to facilitate communication between the client device and the distribution server.

35. The mediation server of claim 34 wherein the contact information includes an address for the distribution server.

36. The mediation server of claim 34 wherein the address includes a universal resource locator (URL) for the distribution server.

37. The mediation server of claim 34 wherein the contact information includes a cryptographic key configured to facilitate secure communication between the client device and the distribution server.

38. The mediation server of claim 37 wherein the cryptographic key is a public cryptographic key.

39. The mediation server of claim 34 wherein the contact information includes an address for the distribution server and a cryptographic key configured to facilitate secure communication between the client device and the distribution server.

40. The mediation server of claim 39 wherein the cryptographic key is a public cryptographic key.

41. The mediation server of claim 34 wherein the instructions are configured such that the mediation server does not send the contact information unless the input was encrypted using a predetermined cryptographic key.

42. The mediation server of claim 41 wherein the predetermined cryptographic key is a private cryptographic key.

43. The mediation server of claim 34 wherein the instructions are further configured to select the distribution server from among a plurality of distribution servers based on the input.

44. In a system having a client device configured to interact with an interactive environment, mediation server, and one or more distribution servers, a method for distributing auxiliary content, comprising:
submitting input from the client device to the mediation server;
receiving input from the client device at the mediation server and sending contact information for a distribution server from the mediation server to the client device in response to the input,
receiving the contact information at the client device; and
using the contact information to contact one or more of the distribution servers with the client device to submit a request for auxiliary content information for an auxiliary content space within an interactive environment implemented with the client device, and servicing the request for auxiliary content information with the one or more distribution servers.

45. An auxiliary content distribution system, comprising:
a mediation server;
one or more client devices; and
one or more distribution servers,
wherein the client device is configured to submit input to the mediation server;
wherein the mediation server is configured to receive input from the client device and send contact information for a distribution server to the client device in response to the input,
wherein the client device is further configured to receive the contact information from the mediation server and use the contact information to contact one or more of the distribution servers with a request for auxiliary content information for an auxiliary content space within an interactive environment implemented with the client device, and
wherein the one or more distribution servers are configured to service requests for auxiliary content information from the one or more client devices.
